(19) United States
(12) Patent Application Publication
(10) Pub. No.: US 2004/0128484 A1
(43) Pub. Date: Jul. 1, 2004

(54) Method and apparatus for transparent delayed write-back

(76) Inventors: Zeev Sperber, Zichron Yaakov (IL); Eitan Rosen, Abirim (IL)

Correspondence Address: KENYON & KENYON, 1500 K STREET, N.W., SUITE 700, WASHINGTON, DC, 20005, US

(21) Appl. No.: 10/330,183

(22) Filed: Dec. 30, 2002

(51) Int. Cl. G06F 9/30

(52) U.S. Cl. 712/218; 712/217

(57) ABSTRACT

Embodiments of the present invention provide a method and system for data exchange between execution units and arrays in a processing unit. Embodiments of the invention may include an execution unit, an out-of-order unit and a delayed write-back buffer coupled between the out-of-order unit and the execution unit. The delayed write-back buffer may dispatch data required by the execution unit for processing.

### TECHNICAL FIELD

The present invention relates to processor units. In particular, the present invention relates to data exchange between execution units and arrays in a processor.

### BACKGROUND OF THE INVENTION

A processor unit such as a central processor unit (CPU) may include a plurality of components such as a controller, an external bus interface unit (BIU), fetch/decode unit, one or more arithmetic logic units (ALUs) or execution units (EU), decoders, a re-order buffer (ROB), a reservation station (RS), level 1 (L1) and level 2 (L2) cache, etc. Instructions and or data (referred to collectively as information) may enter the CPU via the BIU, which is coupled to an external bus. The information may be sent to the other components of the CPU for processing.

Some CPUs include decoders that break down or decode instructions into smaller instructions called micro-operations (uops). Simple instructions may generate only one uop, while more complex instructions may generate several uops. Since instructions are broken down into smaller more manageable uops, the CPU can process these uops more efficiently.

To increase performance, some CPUs can execute program instructions or uops out of their original order in the instruction stream before retiring the results in order. The CPU may use a ROB and an RS to enable out-of-order (OOO) execution. A uop may stay in the reservation station until all the operands and/or data it needs are available. If an operand for one uop is delayed because data is not available and/or a previous uop that generates the operand has not been processed, then the RS may locate another uop later in the queue that can be executed out-of-order to conserve time. Uops that are ready for execution may be sent to an EU for execution.

When a uop has been executed, then it may be marked in the ROB as ready to retire. The uop may be forwarded to a retirement station where the contents of the temporary registers used by the uops may be written to permanent registers. While uops can be executed out-of-order, they must be retired in order.

After the EU executes uops, the resulting data may be written back to the ROB and/or returned to the RS. This write-back (WB) data written on the WB bus may be used in the next cycle for dispatch of a ready cycle, allocation of a new cycle, and/or retirement of a valid uop associated with that data. In some cases, data may need to be read from the RS (e.g., in case of a dispatch) or ROB (e.g., in case of allocation or retirement) immediately after it is written. Depending on the frequency of such read requests, problems can arise since a read that immediately follows a write to the same location of a large array such as an RS or ROB can cause a critical path. Furthermore, the path from the EU to the ROB and RS may be too long and/or may not meet its timing targets.

### BRIEF DESCRIPTION OF THE DRAWINGS

FIG. 1 is a block diagram in accordance with an embodiment of the present invention.

FIG. 2 is another block diagram in accordance with an embodiment of the present invention.

FIG. 3 illustrates a control circuit in accordance with an embodiment of the present invention.

FIG. 4 is a table listing an exemplary operation in accordance with an embodiment of the present invention.

FIG. 5 is a table listing an exemplary operation in accordance with an embodiment of the present invention.

FIG. 6 is a flow chart in accordance with an embodiment of the present invention.

FIG. 7 is a system in accordance with an embodiment of the present invention.

### DETAILED DESCRIPTION

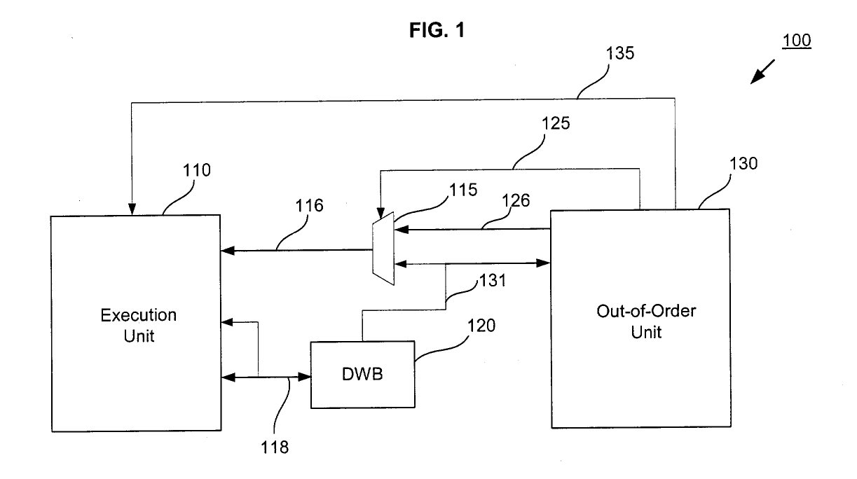

FIG. 1 is a block diagram of a system 100 in accordance with embodiments of the present invention. Embodiments of the present invention may find application in a CPU or other such processing device. As shown in FIG. 1, an execution unit (EU) 110 may be coupled to a delayed write-back buffer (DWB) 120 via a write-back (WB) bus 118, in accordance with an embodiment of the present invention. It is recognized that more than one execution unit 110 may be included in system 100. The WB bus 118 may provide data back to the execution unit 110, as shown. The DWB 120 may be coupled to delayed DWB multiplexer 115 and the out-of-order (OOO) unit 130, as shown. The OOO unit 130 may control the DWB multiplexer 115 via control line 125 and may also control an internal multiplexer (not shown) via control line 135.

In embodiments of the present invention, system 100 may execute program instructions or uops out of their original order in the instruction stream. An execution unit 110 may execute an instruction and may post the results on the WB bus 118. If the EU 110 or another EU needs the resulting data, the data may be retrieved directly from the WB bus 118. In embodiments of the present invention, OOO unit 130 may control multiplexer (not shown) in the EU 110, via control line 135, to select WB bus 118 for receipt of data.

In embodiments of the present invention, the resulting data may be written into the DWB 120 buffer via WB bus 118. In embodiments of the present invention, DWB 120 may include one or more flip-flops or similar devices to store the data. The OOO 130 may monitor the contents of DWB 120 and in the event that data stored in the DWB 120 is needed, the data may be dispatched from the buffer 120. If the data exists in the buffer 120, OOO 130 may control multiplexer 115, via control line 125, to select input line 131 from the buffer 120. The data may then be sent to EU 110 via output 116 for processing.

In embodiments of the present invention, data executed by the EU 110 and stored in the DWB 120 may be written to the internal arrays of the OOO unit 130. The OOO unit 130 can dispatch data stored internally to the EU 110 by selecting input line 126 of multiplexer 115 via control line 125. As the input line 126 is selected, the data may be sent to the EU 110 for processing via output line 116.

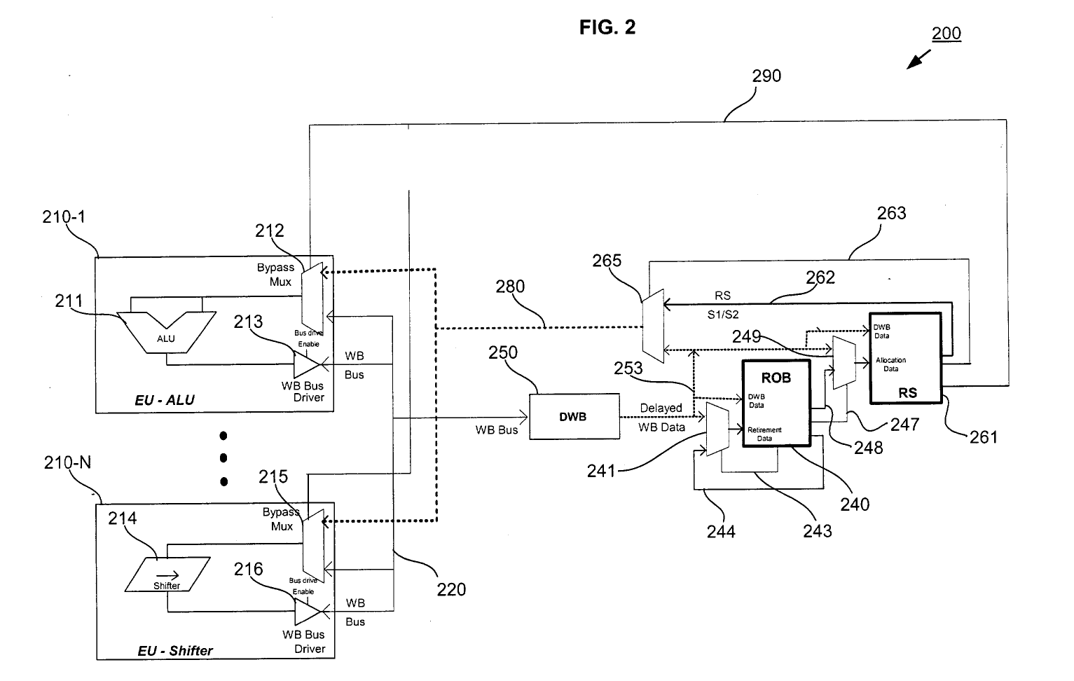

FIG. 2 is a detailed block diagram of system 200 in accordance with embodiments of the present invention. System 200 may include a plurality of EUs 210-1 to 210-N. Each EU 210 may include an arithmetic logic unit (ALU) 211, shifter 214 and/or other processing device. Each of these devices may receive input from bypass multiplexers 212 and 215. Write-back bus drivers such as 213, 216 may post the results from EUs 210-1 to 210-N on WB bus 220. As shown, the WB bus 220 may be input to EUs 210-1 to 210-N as one of the inputs of multiplexers 212, 215. Another input to multiplexers 212, 215 may be received from DWB by-pass multiplexer 265 via line 280.

In embodiments of the present invention, the results from EUs 210-1 to 210-N may be written to DWB 250. DWB 250 may include storage devices such as one or more flip-flops (not shown) or other such devices to store data. The DWB buffer 250 may be coupled to retirement by-pass multiplexer 241, ROB 240 (e.g., for updating result value), allocation by-pass multiplexer 249, RS 261 (e.g., for updating RS sources) and/or the DWB by-pass multiplexer 265 via DWB data bus 253.

In embodiments of the present invention, retirement multiplexer 241 may have a second input from ROB 240 via input line 244. The output of the retirement multiplexer 241 may be sent to the ROB 240 as retirement data. In embodiments of the present invention, during retirement, ROB 240 may control the multiplexer 241 to select input line 244 from the ROB 240 or input line 253 from the DWB 250 using control line 243.

In embodiments of the present invention, allocation multiplexer 249 may have a second input from ROB 240 via input line 248. The output of the allocation multiplexer 249 may be sent to the RS as allocation data 261. During allocation, in embodiments of the present invention, the ROB 240 may control the multiplexer 249 to select input line 248 from the ROB 240, or input line 253 from the DWB 250, using control line 247.

In embodiments of the present invention, the RS 261 may control by-pass multiplexer 265 via control line 263. For example, based on the location and/or availability of data needed by the EU 210, the RS 261 may select RS bus 262 from its internal register array, or alternatively may select input line 253 from DWB 250 to be output by multiplexer 265 via output line 280. Additionally, the RS 261 may also control the internal multiplexers 212, 215, for example, located in EUs 210-1 to 210-N. In embodiments of the invention, RS 261 may select whether input line 280 or the WB bus 220 input should be selected for output to, for example, the ALU 211, shifter 214, or other processing device in the EU 210.

As indicated above, the ROB 240 and RS 261 may enable a CPU to execute instructions out-of-order. For example, a complex instruction may be broken down into one or more micro-operations (uops) which may be processed more efficiently than the instruction as a whole. Additionally, the uop may be executed in any order whenever, for example, the sources or data it needs is ready. As described above, a uop may stay in the RS 261 until the operand or data it needs is available. If an operand for one uop is delayed because data is not available and/or a previous uop that generates the operand has not been processed, then the RS may locate another uop later in the queue that can be executed out-of-order to conserve time. Uops that are ready for execution may be sent to the EUs 210-1 to 210-N for execution.

In embodiments of the present invention, during dispatch, the data that may be needed by the uop may be dispatched, by the RS 261, from the WB bus 220, the DWB 250, or the RS 261, by selection of the appropriate multiplexer input. During retirement, the ROB 240 may select the data for retirement from its internal register array or from the DWB 250 by controlling retirement by-pass multiplexer 241. During allocation, the ROB 240 may select the data for allocation to the RS 261 from the ROB's internal registers or from DWB 250 by controlling the allocation bypass multiplexer.

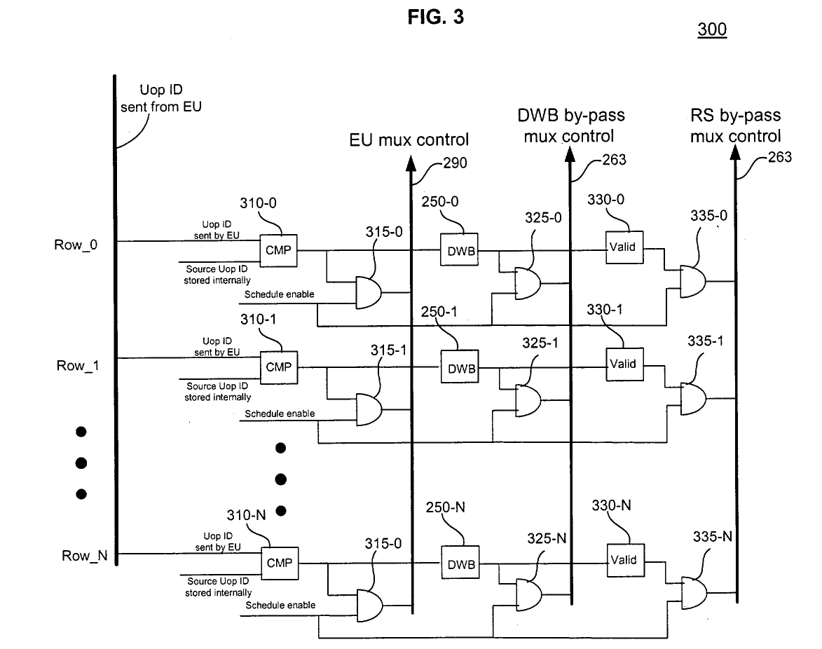

FIG. 3 shows control logic 300 that may be used to control the plurality of by-pass multiplexers in accordance with embodiments of the present invention. Although the by-pass control shown in FIG. 3 refers the by-pass control by the RS 261 to control, during dispatch, multiplexers 265, 212 and 215, for example, it is recognized that similar logic may be used by, for example, the ROB 240 to control the retirement by-pass multiplexer 241 and/or the allocation by-pass multiplexer 249. The by-pass controls discussed may be located internal to the RS and/or ROB, or may be located external to the RS and/or ROB. It is recognized that the control logic 300 is given by way of example only and that any configuration of control logic, in accordance with embodiments of the present invention, may be used.

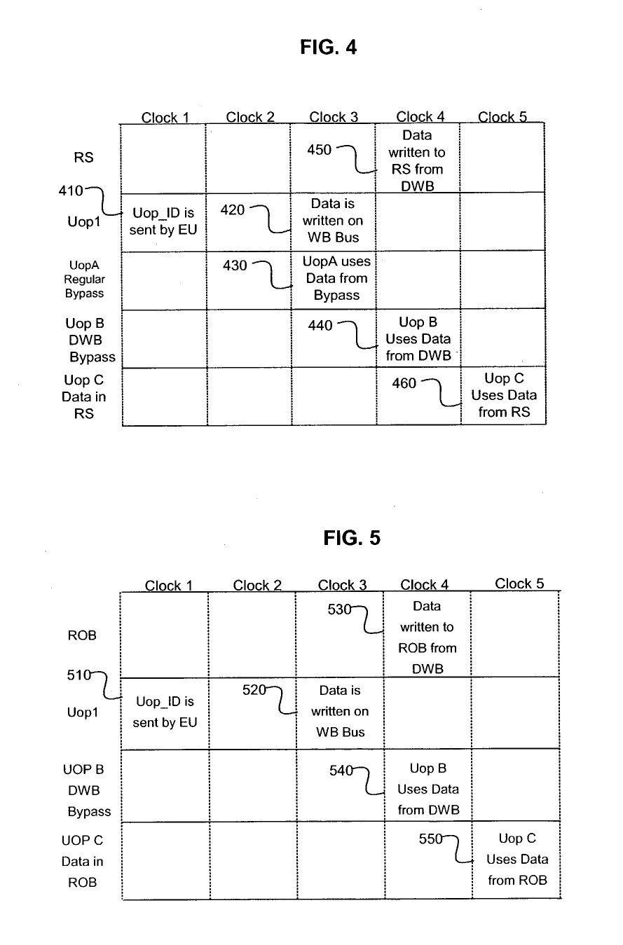

In embodiments of the present invention, the RS 261 and ROB 240 may include a plurality of register arrays referred to as Row_{—}0 to Row_N, as shown in FIG. 4. Each array may store data, uops, and/or source and/or uop identifiers (Uop ID).

Now the operation of an embodiment of the present invention will be described referencing the block diagram of FIG. 3. It is recognized the operation described herein can be performed with respect to each row of Row-0 to Row-N of control logic 300, as shown in FIG. 3. However, for simplicity, only the operation with respect to the Row_{—}0 will be described. Additionally, although reference is made to only the RS 261 and corresponding control of by-pass multiplexers 212, 215, and/or 265 during dispatch, it is recognized that the control logic and operations described herein can be applied to the ROB 240 and corresponding control of multiplexers 241 and/or 261 during retirement and/or allocation, respectively.

In embodiments of the present invention, as shown in FIG. 3, a Uop ID may be sent by EU 410 and may be compared at comparator 310-0 with a source Uop ID stored internally in the RS 261 and/or ROB 240. It is recognized that the Uop ID sent by the EU 410 may be compared at each of the comparators 310-1 to 310-N. If there is a match between the received Uop ID and the Uop ID stored internally, a logical “1” may, for example, be input to one of the inputs of the AND gate 315-0 and ANDed with the schedule enable at the other input of the AND gate 315-0. The schedule enable may be set to a logical “1” if, for example, the RS 261 determines that a dispatch needs to be scheduled and/or the source data is on the WB bus 220.

If both of the inputs to AND gate 315-0, for example, are a logical “1,” the output of the AND gate 315-0 will be a logical “1” and the EU multiplexer (mux) control line 290 will select WB bus input line 220 for output by multiplexer 212, for example. In this case, the data from the WB bus 220 by-pass may be dispatched for the current operation performed by EU 210-1. In the event either the output of the comparator 310-0 or the schedule enable is set to a logical “0,” the output of the AND gate 315-0 will be a logical “0” and the WB bus 220 by-pass may not be selected.

In embodiments of the present invention, if the data is not dispatched from the WB bus 220 because the data was not ready and/or other wise was not scheduled by the RS 261 for dispatch, then the RS 261 may dispatch the data from DWB 250. The output of DWB 250-0 may be a delayed version of the comparator 310-0. The output of DWB 250 may indicate whether the required data is in the DWB 250 and/or is valid. Each delayed version of the comparator may correspond to one buffering level in a DWB. If there is a match between the received Uop ID and the Uop ID stored internally, a logical “1” from comparator 310-0 may be input to one of the inputs of the AND gate 325-0 and ANDed with the schedule enable at the other input of the AND gate 325-0. The schedule enable may be set to a logical “1” if, for example, the RS 261 determines that a dispatch needs to be scheduled and/or the source data is in a DWB 250, for example.

If both of the inputs to AND gate 325-0, for example, are a logical “1,” the output of the AND gate 325-0 will be a logical “1” and the DWB by-pass mux control line 263 may select DWB input line 253 for output by DWB by-pass multiplexer 265, for example. In this case, the data from the DWB 250 may be dispatched to the EU 210-1. In the event either the output of the comparator 310-0 or the schedule enable is set to a logical “0,” the output of the AND gate 325-0 will be a logical “0” and the DWB by-pass control line 263 may not select the DWB input data line 253 for output by DWB by-pass multiplexer 265. In this case, the data from the DWB 250 may not be dispatched to the EU 210-1, for example.

In embodiments of the present invention, if the data is not dispatched from the WB bus 220 and/or DWB 250, then the RS 261 may dispatch the data from its internal register array, if the data in the RS 261. The output of 330-0 may indicate whether data is valid in the RS 261. If there is a match between the Uop ID received from the EU 210-1 and the source Uop ID stored internally, a logical “1” from comparator 310-0 may be delayed by a number of clocks according to the number of buffers in the DWB. If the data in valid in the RS, the output of the 330-0 may be a logical “1” that may be input to one of the inputs of the AND gate 335-0 and ANDed with the schedule enable at the other input of the AND gate 335-0. The schedule enable may be set to a logical “1” if, for example, the RS 261 determines that a dispatch needs to be scheduled and/or the source data is in its internal registers is valid, for example.

If both of the inputs to AND gate 335-0, for example, are a logical “1,” the output of the AND gate 335-0 will be a logical “1” and the DWB by-pass mux control line 263 may select the RS bus 262 for output by DWB by-pass multiplexer 265, for example. In this case, the data from the RS 261 may be dispatched to the EU 210-1, for example. In the event either the output of the comparator 310-0 or the schedule enable is set to a logical “0,” the output of the AND gate 335-0 will be a logical “0” and the DWB by-pass control line 263 may not select the RS bus 262 for output by DWB by-pass multiplexer 265. In this case, the data from the RS 261 may not be dispatched to the EU 210-1, for example.

Although FIG. 3 and the description above relate to the dispatch of data to the EU210, it is recognized that similar control logic may be implemented by, for example, the ROB 240 or an external controller during retirement and/or allocation. For example, during retirement, the Uop ID sent from the EU 210 may be compared with a retirement Uop ID. If there is a match, the ROB 240 may select the DWB input data line 253 to retirement by-pass multiplexer 241 via control line 243. Accordingly, data from the DWB 250 may be used for retirement by the ROB 240. If there is not a match, the ROB 240 may select the ROB retirement data line 244 input to retirement by-pass multiplexer 241 via control line 243. Accordingly, the ROB 240 may use data from its internal registers for retirement.

During allocation, in accordance with embodiments of the present invention, the Uop ID sent from the EU 210 may be compared with an allocation Uop ID. If there is a match, the ROB 240 may select the DWB input data line 253 to allocation by-pass multiplexer 249 via control line 247. Accordingly, data from the DWB 250 may be used for allocation to the RS 261 by the ROB 240. If there is not a match, the ROB 240 may select the ROB allocation data line 248 input to allocation by-pass multiplexer 249 via control line 247. Accordingly data from the ROB's 240 internal register array may be used for allocation to the RS 261.

FIG. 4 is a table describing an example of a dispatch operation in accordance with an embodiment of the present invention. At clock 1, a Uop ID is sent by an EU 210 indicating that data corresponding to the Uop ID may be written on the WB bus 220, as shown in 410. At clock 3, for example, data may be written on the WB bus, as shown in 420. In one example, Uop A being executed by the EU 210-1 may require the data and the data may be selected from the WB bus 220 by by-pass multiplexer 212 in the EU 210-1, as shown in 420. Additionally, at clock 3, the data posted on the WB bus 220 may be written to DWB 250.

At clock 4, for example, Uop B being executed in the EU 210-1 may require the data and the data may be selected from the WBD buffer 250 by by-pass multiplexer 265, as shown in 440. In the example, the data may be written to the RS 261 from the DWB 250 at clock 4, as shown in 450. At clock 5, for example, Uop C being executed in the EU 210-1 may require the data and the data may be selected from the RS 261 by by-pass multiplexer 265, as shown in 460. It is recognized that the above description relates to only an example of a dispatch operation, in accordance with embodiments of the present invention, and should not be construed as limiting. Variations to the dispatch operation that are within the scope and spirit of the invention may be made by one of ordinary skill in the art.

FIG. 5 is a table describing an example of retirement and/or allocation operations in accordance with embodiments of the present invention. At clock 1, a Uop ID is sent by an EU 210 indicating that data corresponding to the Uop ID may be written on the WB bus 220, as shown in 510. At clock 3, for example, data may be written on the WB bus, as shown in 520. Additionally, at clock 3, the data posted on the WB bus 220 may be written to DWB 250.

At clock 4, in embodiments of the present invention, the data may be by-passed to the ROB 240, via multiplexer 241, from the WBD buffer 250 for retirement and/or may be by-passed to the RS 240, via multiplexer 249, from the WBD buffer 250 for allocation. Also in clock 4, for example, the data may be written from the DWB 250 to the ROB 240, as shown in 530. In embodiments of the present invention, the ROB 240 may determine that the data may be associated with, for example, a source of Uop B, based on the Uop ID, is ready for allocation to the RS 262 and should use the data in the DWB 250. Also, the ROB 240 may determine that the data may be associated with, for example, the retired value of the Uop (e.g., Uop B=Uop 1), based on the Uop ID, is ready for retirement in the ROB 240 and/or should use the data in the DWB 250. At clock 5, for example, Uop C may use data written to the ROB 240 for retirement and/or for allocation, as shown in 550.

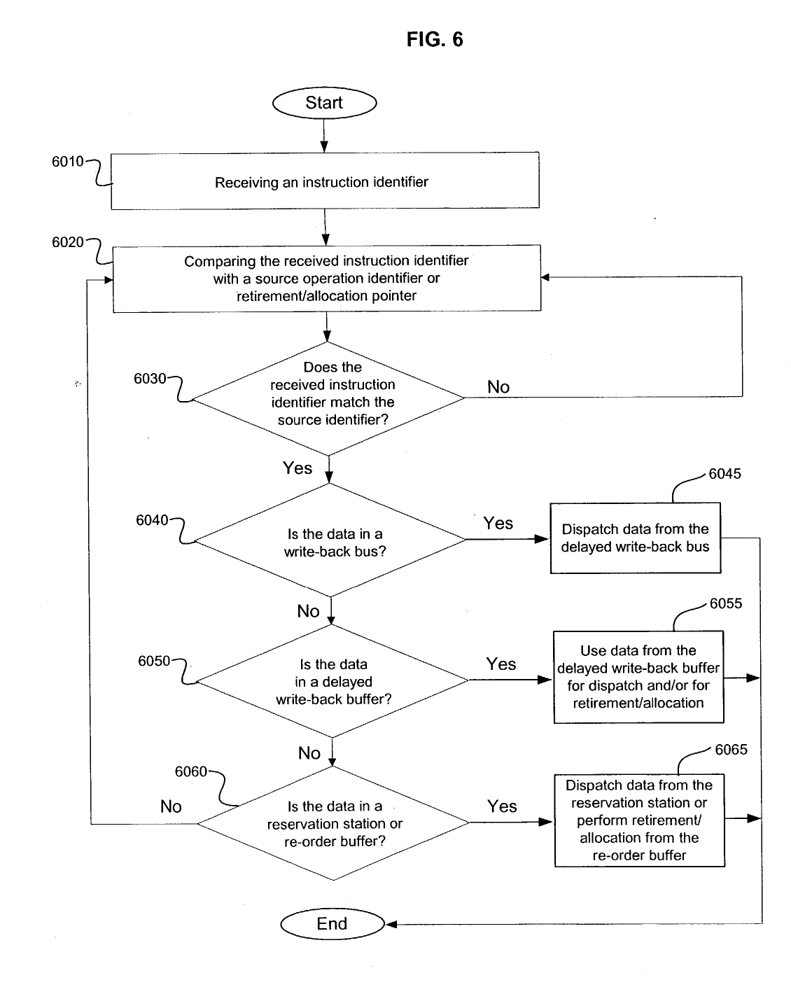

FIG. 6 is a flow chart in accordance with an embodiment of the present invention. An instruction identifier (e.g., Uop ID) sent by the EU 210 may be received, as shown in 6010. The received instruction identifier may indicate that the data associated with the instruction identifier may be valid and/or written to the WB bus 220 at a later time, for example, two clock cycles later. In embodiments of the present invention, the instruction identifier may be received by the ROB 240, RS 261 or another device such as a controller. The received instruction identifier may be compared with a source operation identifier stored internally in the RS 261, or the received instruction identifier may be compared with the allocation or retirement pointer in the ROB 240, as shown in 6020 and 6030. If there is no match, the device may continue to monitor the received instruction identifiers and compare the received identifier with the source operation identifier or the allocation or retirement pointer, as shown in 6030 and 6020. If there is a match, and the data associated with the instruction identifier resides in the DWB 250, the data may be dispatched from the WB bus 220, as shown in 6040 and 6045.

In embodiments of the present invention, if there is a match and the data is not in the write-back bus, the RS 261 may determine whether the data is in the DWB 250, as shown in 6040 and 6050. If the data is determined to be in the DWB 250, the data from the DWB 250 may be used for dispatch and/or for retirement/allocation, as shown in 6050 and 6055.

In embodiments of the present invention, if the data is determined not to be in the delayed DWB 250, as shown in 6050, it is determined whether the data is in either the RS 261 or ROB 240, as shown in 6060. During dispatch, if the data is in the RS 261, the data is dispatched from the RS 261, as shown in 6065. During retirement and/or allocation, if the data is in the ROB 240, then retirement and/or allocation is performed from the ROB 240, as shown in 6065.

In embodiments of the present invention, if the data is not in the RS 261 and/or ROB 240, as shown in 6060, the device may continue to monitor the received instruction identifiers and compare the received identifier with the source operation identifier or the allocation or retirement pointer, as shown in 6020.

Embodiments of the present invention provide to a transparent delayed write-back that may break the path from the EU to the RS/ROB. This leaves one clock path from the EU via the WB bus to another EU to limit the frequency of immediate reads from large memory arrays that make up the RS and/or ROB. The addition of the DWB closer to the EU, and/or faster than RS and/or ROB arrays, may increase the overall performance of the system. For example, the addition of the DWB may remove the RS out of the loop and/or may make it non-critical when, for example, the data is dispatched from the DWB. This may allow the saving of power and/or may contribute to the overall performance of the system.

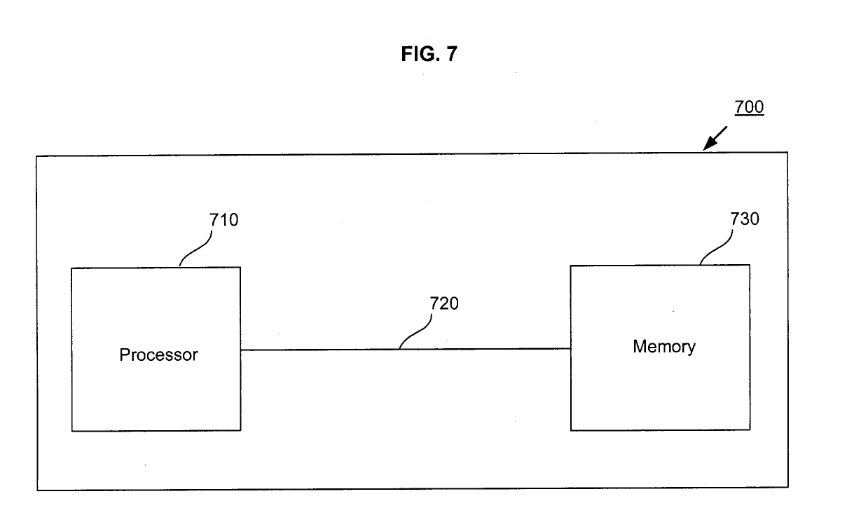

FIG. 7 show a computer system 700 in accordance with embodiments of the present invention. The system 700 may include, among other components, a processor 710, a memory 730 and a bus coupling the processor 710 to memory 730.

In embodiments of the present invention, the processor 710 may incorporate the systems 100 and 200 as shown in the figures and described herein. It is recognized that the processor 710 may include any variation the systems described herein that are within the scope of the present invention. For example, the processor 710 may include the various execution units, DWBs, the various multiplexers, the OOO unit including the ROB and/or RS, etc.

The system 700 may employ embodiments of the present invention. In operation, for example, the EUs 210, RS 261, the ROB 250, or other components in the processor may request data that is stored in memory 710. Accordingly, the processor may post a request for the data on the bus 720. In response, the memory 730 may post the requested data on the bus 720. The processor may read the requested data from the bus 720 and process it as needed. The data may be processed by the processor 710 in accordance with embodiments of the present invention.

If however the requested data is located in one of the components of the processor, the data may be processed in accordance with embodiments of the present invention as described herein. For example, if the data requested by the EU 210 is in the DWB 120, the DWB 250 dispatches the data to, for example, EU 210 for processing via multiplexers 265 and 212.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. An apparatus comprising:
an execution unit;
an out-of-order unit; and
a delayed write-back buffer coupled between the out-of-order unit and the execution unit, wherein the delayed write-back buffer is to dispatch data required by the execution unit for processing.

2. The apparatus of claim 1, wherein the delayed write-back buffer includes a flip-flop.

3. The apparatus of claim 1, wherein the out-of-order unit comprises:
a re-order buffer to store results received from the execution unit.

4. The apparatus of claim 3, further comprising:
a retirement bypass multiplexer that has a first input from the re-order buffer and a second input from the delayed write-back buffer, wherein the re-order buffer is to select at least one of the first input and the second input to be output to the re-order buffer to be retired.

5. The apparatus of claim 3, further comprising:
a reservation station;
an allocation bypass multiplexer that has a first input from the re-order buffer and a second input from the delayed write-back buffer, wherein the re-order buffer is to select at least one of the first input and the second input to be output to the reservation station to be allocated.

6. The apparatus of claim 1, wherein the out-of-order unit comprises:
a reservation station to store a command and the data.

7. The apparatus of claim 6, wherein the delayed write-back buffer is to delay a write-back to the reservation station.

8. The apparatus of claim 7, wherein the delayed write-back buffer is to write to the reservation in a next clock cycle.

9. The apparatus of claim 6, further comprising:
a dispatch bypass multiplexer that has a first input from the reservation station and a second input from the delayed write-back buffer, wherein the reservation station is to select at least one of the first input and the second input to be output to the execution unit to be processed.

10. The apparatus of claim 9, wherein the execution unit comprises:
a execution bypass multiplexer that has a first input from the dispatch multiplexer and a second input from the delayed write-back buffer, wherein the execution unit is to select at least one of the first input and the second input to be output for processing.

11. The apparatus of claim 10, wherein the execution bypass multiplexer has a third input from a write-back bus.

12. The apparatus of claim 10, wherein the execution unit further comprises:
an arithmetic logic unit that is to receive the output from the dispatch multiplexer for processing.

13. The apparatus of claim 10, wherein the execution unit further comprises:
a shifter that is to receive the output from the dispatch multiplexer for processing.

14. The apparatus of claim 1, further comprising:
a write-back bus to couple the execution unit to the delayed write-back buffer.

15. A method comprising:
receiving an instruction identifier from an execution unit;
comparing the received instruction identifier with a source operation identifier; and
if the data is in a delayed write-back buffer at a time when a data dispatch is scheduled and, there is a match between the received instruction identifier and the source operation identifier, dispatching data associated with the source operation identifier from the delayed write-back buffer.

16. The method of claim 15, wherein dispatching the data from the delayed write-back buffer comprises:
selecting for output a multiplexer input coupled to the delayed write-back buffer.

17. The method of claim 16, wherein the data is provided to the multiplexer input.

18. The method of claim 15, further comprising:
dispatching data from the write-back bus, if the data is in a write-back bus at the time when a data dispatch is scheduled and, there is a match between the received instruction identifier and the source operation identifier.

19. The method of claim 18, wherein dispatching the data from the write-back bus comprises:
selecting for output a multiplexer input coupled to the write-back bus.

20. The method of claim 19, wherein the data is provided to the multiplexer input.

21. The method of claim 15, further comprising:
if the data is in a reservation station at the time when a data dispatch is scheduled and, there is a match between the received instruction identifier and the source operation identifier, dispatching data from the reservation station.

22. The method of claim 21, wherein dispatching the data from the write-back bus comprises:
selecting for output a multiplexer input coupled to the reservation station.

23. The method of claim 22, wherein the data is provided to the multiplexer input.

24. The method of claim 15, further comprising:
writing the data from the delayed write-back buffer to a reservation station.

25. The method of claim 15, further comprising:
writing the data from the delayed write-back buffer to a read-order buffer.

26. The method of claim 15, further comprising:
comparing a retirement identifier with the received instruction identifier, and
during retirement, reading data associated with the retirement identifier from the delayed write-back buffer.

27. The method of claim 15, further comprising:
comparing an allocation identifier with the received instruction identifier, and
during allocation, reading data associated with the allocation identifier from the delayed write-back buffer.

28. A method comprising:
comparing a received instruction identifier with a stored source operation identifier;
writing data associated with the received instruction identifier on a write-back bus;
writing data associated with the received instruction identifier in a delayed write-back buffer;
selecting the written data, for dispatch, from the delayed write-back buffer; and
processing an instruction operation based on the data dispatched from the write-back buffer.

29. The method of claim 28, further comprising:
writing data to a reservation station from the delayed write-back buffer.

30. The method of claim 28, further comprising:
selecting the written data, for retirement, from the delayed write-back buffer.

31. The method of claim 28, further comprising:
selecting the written data, for allocation, from the delayed write-back buffer.

32. A system comprising:
a bus;
an external memory coupled to the bus; and
a processor coupled to the bus, the processor including:
an execution unit;
an out-of-order unit; and
a delayed write-back buffer coupled between the out-of-order unit and the execution unit, wherein if data requested by the execution is unit is stored in the external memory, the processor is to post a request on the bus for the requested data stored in the external memory, and if the data requested by the execution unit is in the delayed write-back buffer, the delayed write-back buffer is to dispatch the data from the delayed write-back buffer.

33. The system of claim 32, wherein responsive to the request posted by the processor on the bus, the memory is to post the requested on the bus.

34. The system of claim 32, wherein the out-of-order unit comprises:
a re-order buffer to store results received from the execution unit.

35. The system of claim 32, the processor further comprises:
a retirement bypass multiplexer that has a first input from the re-order buffer and a second input from the delayed write-back buffer, wherein the re-order buffer is to select at least one of the first input and the second input to be output to the re-order buffer to be retired.

36. The system of claim 32, the processor further comprises:
a reservation station;
an allocation bypass multiplexer that has a first input from the re-order buffer and a second input from the delayed write-back buffer, wherein the re-order buffer is to select at least one of the first input and the second input to be output to the reservation station to be allocated.

37. The system of claim 32, wherein the out-of-order unit comprises:
a reservation station to store a command and the data.

38. The system of claim 32, wherein the delayed write-back buffer is to delay a write-back to the reservation station.

39. The system of claim 38, wherein the delayed write-back buffer is to write to the reservation in a next clock cycle.

40. The system of claim 32, the processor further comprises:
a dispatch bypass multiplexer that has a first input from the reservation station and a second input from the delayed write-back buffer, wherein the reservation station is to select at least one of the first input and the second input to be output to the execution unit to be processed.

41. The system of claim 32, wherein the execution unit comprises:
a execution bypass multiplexer that has a first input from the dispatch multiplexer and a second input from the delayed write-back buffer, wherein the execution unit is to select at least one of the first input and the second input to be output for processing.
